(19) United States
(12) Patent Application Publication
(10) Pub. No.: US 2026/0301007 A1
(43) Pub. Date: Oct. 1, 2026

(54) METHOD AND SYSTEM FOR GENERATING EXPLAINABLE TASK-BASED OPTIMIZATION

(71) Applicant: Panasonic Intellectual Property Management Co., Ltd., Osaka (JP)

(72) Inventors: DEBDEEP PAUL, Singapore (SG); YONGNING YIN, Singapore (SG); CHANDRA SUWANDI WIJAYA, Singapore (SG); SAHIM YAMAURA, Singapore (SG); KOJI MIURA, Osaka (JP)

(21) Appl. No.: 19/090,460

(22) Filed: Mar. 26, 2025

(51) Int. Cl. G06Q 30/0202; G06N 20/00; G06Q 30/0201

(52) U.S. Cl. CPC G06Q 30/0202; G06N 20/00; G06Q 30/0206

(57) ABSTRACT

The present disclosure relates to a method for explainable task-based optimization. The method includes receiving a target decision variable that is of interest to the user and an auxiliary dataset associated with a decision-making problem. Further, the method includes generating a prediction of the target decision variable using a forecasting machine learning (ML) model. Furthermore, the method includes determining an optimal decision variable for the decision-making problem with uncertain parameters and variables. Furthermore, the method includes executing the optimal decision variable and determining an actual cost outcome. Furthermore, the method includes updating the forecasting ML model using a rolling window technique based on the actual cost outcomes. Furthermore, the method includes evaluating the actual cost outcome of an executed decision based on comparing with the optimal performance and updating optimization parameters based on the actual cost outcome to refine the forecasting ML model.

### FIELD OF THE INVENTION

The present disclosure relates generally to artificial intelligence, and more specifically, to a method and a system for generating end-to-end explainable task-based optimization.

### BACKGROUND

Effective decision-making in complex, uncertain environments present significant technical challenges across various domains, such as inventory management, energy optimization, and supply chain logistics. Traditional forecasting and optimization approach often operate in isolation, leading to suboptimal outcomes due to misaligned objectives. The existing artificial intelligence (AI)-based forecasting models typically minimize statistical errors (e.g., mean squared error (MSE) and root mean squared error (RMSE)) without considering the direct impact on downstream optimization performance, while on the other hand optimization models rely on uncertain input parameters that are not adaptively refined over time. Additionally, decision-making often involves multiple constraints, risk considerations, and auxiliary data sources, such as supplier reliability, demand fluctuations, and external market indicators. Consequently, the inability of the forecasting models dynamically updates forecasts, integrate real-world business constraints, and optimize decision variables based on actual cost outcomes (e.g., generated via the optimization models) leads to inefficiencies, increased operational risks, and suboptimal resource allocation. Thus, it is required to address the technical challenge using a unified framework that continuously refines both forecasting and optimization components through adaptive feedback loops, ensuring decisions are not only data-driven but also cost-effective and explainable.

In an example scenario, in complex business environments such as a warehouse, inventory management plays a crucial role in ensuring the efficient allocation of resources while maintaining financial stability. However, managing inventory effectively presents a significant technical challenge due to the inherent uncertainty in demand forecasting, supplier reliability, and cost fluctuations. The difficulty is amplified in business settings, where businesses must handle supply chain complexities, multiple vendors with varying costs and lead times, and the risk of financial losses due to mismanaged stock levels. Traditional inventory management approaches often rely on historical data and simplistic forecasting models that do not account for dynamic market changes, leading to suboptimal decision-making. Consequently, resulting in excessive holding costs, stockouts, over-purchasing, or the inability to meet customer demand efficiently, directly impacting a company's operational efficiency and cash flow.

Further in the example scenario, a primary technical challenge in inventory management is the optimization of order quantity and procurement timing under conditions of uncertainty. For instance, businesses must determine the inventory to be ordered and when to order while considering factors such as procurement costs, product lifespan, and the risk of obsolescence. The problem is further complicated by stochastic demand patterns, where customer requirements are highly unpredictable due to external influences like seasonal demand shifts, economic fluctuations, or sudden changes in market trends. Unlike retail environments, where demand may follow more predictable trends, inventory management is impacted by bulk orders, contract-based supply chains, and varying vendor capabilities, making forecasting even more complex.

Furthermore, in the example scenario, another major problem is managing a multi-vendor supply chain in a multi-tier setting, where each supplier has different pricing structures, lead times, and reliability metrics. Businesses must trade-offs between selecting a cheaper vendor with a longer lead time or a more expensive vendor who can deliver faster and more reliably. Further, certain decisions such as avoiding major risks in inventory optimization related to missing demand or supply shortage become even more intricate when dealing with perishable inventory, specialized components with limited suppliers, or fluctuating raw material costs. The inability to dynamically adjust procurement strategies based on real-time supplier performance and changing market conditions leads to increased risk exposure.

Furthermore, in the example scenario, assuming a medical equipment supplier that distributes essential hospital supplies, such as ventilators and diagnostic devices, to healthcare facilities. The medical equipment supplier must ensure that hospitals receive the necessary equipment on time without overstocking or running into shortages. Each piece of equipment involves multiple components sourced from different vendors, each with varying lead times and pricing structures. Some vendors offer lower-cost components with longer delivery times, while others provide high-quality parts at a premium price but with shorter fulfillment windows. The medical equipment supplier must balance these constraints while predicting demand for different hospitals, which fluctuates based on disease outbreaks, seasonal patient intake, and emergency orders.

If the supplier underestimates demand, hospitals may face critical shortages, leading to delays in medical procedures and potential health risks. On the other hand, if the supplier overestimates demand, they may overstock expensive equipment that quickly becomes obsolete due to technological advancements. Additionally, unexpected supplier delays or regulatory compliance issues can further disrupt the supply chain. In such scenarios, the traditional forecasting models struggle to incorporate discussed complexities, as the traditional forecasting models often assume static demand patterns and fail to integrate real-time market intelligence.

Moreover, another challenge arises in evaluating the true cost impact of procurement decisions. Businesses often optimize inventory based on standard forecasting accuracy metrics like Mean Squared Error (MSE) or Root Mean Squared Error (RMSE), which do not directly align with the actual cost impact on operations. For instance, in the medical equipment scenario, a forecast error leading to a stockout of critical components has a significantly higher financial and reputational impact than an error leading to excess stock. Existing techniques do not provide an integrated approach where prediction and optimization are jointly tuned based on real business performance metrics rather than generic statistical accuracy.

Therefore, the technical problem focuses on the difficulty of optimizing inventory procurement in uncertain and dynamic environments while managing multiple vendors with different constraints, incorporating real-time auxiliary data for better forecasting, and aligning prediction models with actual business impact rather than traditional accuracy measures. The technical challenge requires an approach that may adaptively update forecasts, evaluate procurement decisions based on actual costs, and integrate external market insights to improve decision-making.

In an example scenario, the existing techniques fail to provide efficient management of supply and demand in modern electricity grid operations due to the inherent uncertainties in renewable energy generation. Unlike conventional power sources, renewable energy sources such as wind and solar are uncontrollable and highly dependent on external factors like weather conditions. This unpredictability creates difficulties in ensuring a stable and cost-effective energy supply. It is required that grid operators solve a stochastic optimization problem that balances power generation from conventional and renewable sources while adhering to operational and physical constraints. The primary objective is to minimize the total operational cost, which includes generation costs influenced by energy tariffs and incentives for renewable integration, distribution costs, power loss costs, and the potential financial risks associated with outages. However, critical parameters such as electricity demand and renewable energy availability are not known in advance, and decisions must rely on forecasts that may be inaccurate. This uncertainty complicates optimal scheduling and resource allocation, leading to inefficiencies and increased operational risks.

Therefore, there is a need for a solution to address the aforementioned issues and challenges.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for explainable task-based optimization is disclosed. The method includes receiving a target decision variable that is of interest to the user and an auxiliary dataset associated with a decision-making problem. Further, the method includes generating a prediction of the target decision variable using a forecasting machine learning (ML) model. Furthermore, the method includes determining an optimal decision variable for the decision-making problem with uncertain parameters and variables, based on the predicted target decision variable, the auxiliary dataset, user-defined constraints, and risk aversion parameters. Furthermore, the method includes executing the optimal decision variable and determining an actual cost outcome based on the execution of the optimal decision as computed for the decision-making problem. Furthermore, the method includes updating the forecasting ML model using a rolling window technique based on the actual cost outcomes. Furthermore, the method includes evaluating the actual cost outcome of an executed decision based on comparing with the optimal performance. Furthermore, the method includes updating optimization parameters based on the actual cost outcome to refine the forecasting ML model.

According to an embodiment of the present disclosure, a system for explainable task-based optimization is disclosed. The system includes a memory and at least one processor. The at least one processor is configured to receive a target decision variable that is of interest to the user and an auxiliary dataset associated with a decision-making problem. Further, the at least one processor is configured to generate a prediction of the target decision variable using a forecasting machine learning (ML) model. Furthermore, the at least one processor is configured to determine an optimal decision variable for the decision-making problem with uncertain parameters and variables, based on the predicted target decision variable, the auxiliary dataset, user-defined constraints, and risk aversion parameters. Furthermore, the at least one processor is configured to execute the optimal decision variable and determine an actual cost outcome based on the execution of the optimal decision as computed for the decision-making problem. Furthermore, the at least one processor is configured to update the forecasting ML model using a rolling window technique based on the actual cost outcomes. Furthermore, the at least one processor is configured to evaluate the actual cost outcome of an executed decision based on comparing with the optimal performance. Furthermore, the at least one processor is configured to update optimization parameters based on the actual cost outcome to refine the forecasting ML model.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a system for generating an explainable task-based optimization solution or forecast, according to an embodiment of the present disclosure;

FIG. 2 illustrates a schematic block diagram of components of the system for generating the explainable task-based optimization, according to an embodiment of the present invention;

FIG. 3 illustrates an exemplary process flow of the system, according to an embodiment of the present invention;

FIG. 4 illustrates a use-case depicting the generation of the explainable task-based optimization on an output console or graphical user interface (GUI), according to an embodiment of the present invention; and

FIG. 5 illustrates a flowchart depicting a method for generating the explainable task-based optimization using the system, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

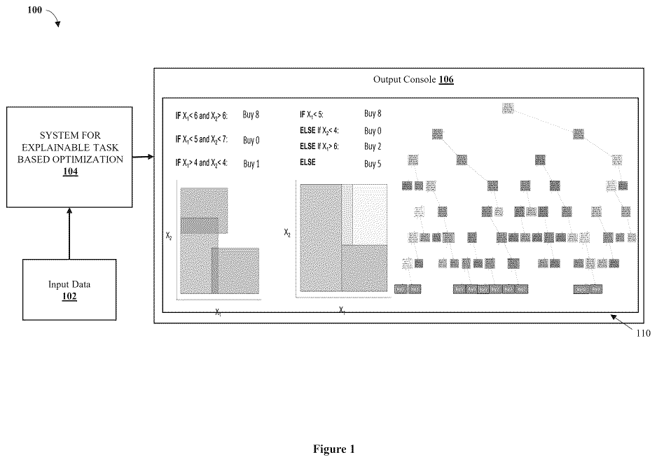

FIG. 1 illustrates an environment 100 comprising a system 104 for an explainable task-based optimization solution 110, according to an embodiment of the present disclosure.

In an embodiment, the system 104 is communicatively coupled to an input data source 102 and an output device 106 advantageously enabling seamless data ingestion, processing, and result visualization. The system 104 may be configured to receive the input data 102.

In a non-limiting example, the input data 102 may include a target decision variable of interest to the user. The target decision variable may correspond to the primary decision to be optimized in a given problem context, for instance, the target decision variable refers to an order quantity in inventory management, energy allocation in power grids, or resource distribution in logistics example scenarios.

Further, in a non-limiting example, the input data 102 may include an auxiliary dataset associated with a decision-making problem, comprising contextual information that influences the target decision variable. For instance, the auxiliary data may include ordering history, storage constraints, shortfall costs, salvage value, shelf life, or external demand indicators. The auxiliary data may be received from an integrated external auxiliary data sources such as real-time web search trend analysis, sentiment analysis using large language models (LLMs) and topic modelling based on historical demand patterns.

Furthermore, in a non-limiting example, the input data may include user-defined constraints, which establish operational boundaries that must be adhered to during the optimization process by the system 104. For instance, the user-defined constraints may include inventory thresholds, budget limitations, regulatory compliance conditions, supply chain constraints, or energy consumption caps.

Furthermore, in a non-limiting example, the input data may include risk aversion parameters, which define the user's tolerance for uncertainty and potential deviations from expected outcomes. The risk aversion parameters may influence a conservative approach of the system 104 in making decisions under uncertainty.

In an embodiment, once the input data 102 is received, the system 104 may be configured to initiate a multi-step process to generate an optimal and explainable decision-making strategy as outlined in forthcoming paragraphs.

The system 104 may be configured to employ a forecasting machine learning (ML) model to generate a predictive estimate of the target decision variable. In an advantageous aspect, unlike the traditional forecasting models that minimize statistical errors (e.g., mean squared error (MSE)), the predictive estimate of the target decision variable by the system 104 directly aligns with the downstream optimization objective.

In an embodiment, the system 104 may be configured to determine an optimal decision variable (e.g. inventory to be ordered) for a stochastic optimization problem (i.e., the decision-making problem) with uncertain parameters and constraints. The optimal decision variable determination may incorporate the predicted target decision variable, the auxiliary dataset, the user-defined constraints, and the risk aversion parameters to compute an optimal action. In an example, the system 104 may employ a Stochastic Optimization Model (SOM) to determine the optimal decision variable. In the example, the SOM is a decision-making framework, which depends on the predictions from the forecasting ML model but primarily applies mathematical or algorithmic optimization techniques for computing (determining) the optimal decision (i.e., the optimal decision variable) while considering constraints and uncertainties.

In an embodiment, the system 104 may be configured to execute (e.g., as decisions) the optimal decision variable in a simulated or real-world environment in the form of implementing the decision (e.g., placing an order). Further, the system 104 may be configured to evaluate an actual cost outcome. The actual cost outcome represents the realized impact of the executed decision, measured in terms of performance metrics such as cost savings, efficiency improvements, or risk mitigation (e.g., whether stockouts occurred, or whether costs deviate from expected values). Furthermore, the actual cost outcome indicates the realized impact of the executed decision on the end-to-end system measured with respect to a specific objective function, customized for the task at hand, including deviations from expected costs that could have been achieved otherwise, constraint violations, risk exposure, decision robustness, and overall system performance.

Furthermore, the system 104 may be configured to update the forecasting ML model using a rolling window technique to enhance predictive accuracy over time. In an advantageous aspect, updating the forecasting ML model based on the actual cost outcome leverages recent actual cost outcomes to refine subsequent forecasts dynamically, consequently ensuring that the system 104 adapts to changing market conditions and decision impact trends.

Furthermore, the system 104 may be configured to re-evaluate the actual cost outcome based on comparing it with the optimal expected performance. Thus, if deviations are detected upon comparison, then optimization parameters in the SOM are adjusted accordingly to refine future decision-making processes, based on observed deviations from expected results as per the actual cost outcome. The optimization parameters refer to configurable factors (i.e., the optimal decision variable) of the SOM that influence the decisions made by the system 104 in the stochastic optimization problem. In a non-limiting example, the optimization parameters may include penalties for constraint violations and risk-adjusted cost deviations. These optimization parameters impact the balance trade-offs, handle uncertainty, and refine decision-making over time in the system 104. The optimization parameters define the behaviour of the SOM and consequently influence the determination of the optimal decision variable. In an example scenario, if an inventory model initially underestimates demand, leading to frequent stockouts, the system 104 may update the optimization parameters by increasing the penalty for stockouts in the next iteration.

Accordingly, in an advantageous aspect, the updating of the optimization parameters ensures continuous improvement in both forecasting accuracy (i.e., by the forecasting ML model) and optimization effectiveness (i.e., by the SOM).

In an embodiment, the system 104 may be configured to generate the explainable task-based optimization solutions (also referred to as insights). In an example, the explainability may be generated using model interpretation techniques such as SHAP (Shapley Additive Explanations) and LIME (Local Interpretable Model-Agnostic Explanations), advantageously allowing users to understand the key factors influencing optimization outcomes (e.g., the insights).

In an advantageous aspect, thus based on iteratively refining the forecasting ML model and the SOM, the system 104 may be configured to ensure that decision-making remains data-driven, cost-efficient, risk-aware, and explainable. Consequently, the system 104 delivers the explainable task-based optimization solution 110 on a graphical user interface (GUI) or the output console 106, thus enabling users to make informed decisions with greater confidence in high-uncertainty environments.

In an embodiment, the system 104 may correspond to a stand-alone system provided on an electronic device. The electronic device may include a personal computing device, a user equipment, a laptop, a tablet, a mobile communication device, or any other device capable of hosting processing and memory units. In an embodiment, the explainable task-based optimization solutions 110 (also referred to as insights 110) may be generated on the output console 106 alternatively referred to as the output device 106 communicatively coupled to the system 104 or may be integrated with the electronic device hosting the system 104. In an alternate embodiment, the output device 106 may be a separate device from the electronic device hosting the system 104.

In another embodiment, the system 104 may be based in a server/cloud architecture and the system 104 may be communicably coupled to the output device 106 via a network (not shown). The network may be a communication network, a wireless network, a wired network, and the like. In another embodiment, the system 104 may be provided in a distributed manner, in that, one or more components of the system 104 may be provided, one or more components and/or functionalities of the system 104 are provided through an electronic device, and one or more components and/or functionalities of the system 104 are provided through a cloud-based unit, such as a cloud storage or a cloud-based server.

In non-limiting examples, the output device 106 providing or displaying the explainable task-based optimization solutions 110 (also referred to as insights 110) may include, but is not limited to, a display unit, an indicating device, a recording device, a computing device, and so forth. In an embodiment, the output device 106 may be associated with a graphical user interface, an interactive user interface, and the like.

In an example scenario for implementation of the system 104 in an inventory management wherein a company is responsible for ordering and managing stock levels across multiple suppliers. The company decides inventory to be ordered while considering uncertain customer demand, varying supplier lead times, storage constraints, and cost factors.

In the example scenario, the system 104 receives the input data 102, which may include the target decision variable e.g., an optimal order quantity to be placed with suppliers. Further, the auxiliary dataset including the historical order data, supplier reliability metrics, product shelf life, shortage costs, salvage value, and real-time demand indicators such as web search trends and sentiment analysis is also provided as the input data 102. Furthermore, the user (i.e., the company) provides user-defined constraints i.e., maximum warehouse capacity, minimum order quantity from suppliers, budget constraints, and contract limitations as the input data 102. Furthermore, the company's tolerance for stockout risks versus holding excessive inventory, which affects decisions under uncertain demand (risk aversion parameters) is also provided as the input data 102.

In the example scenario, the system 104 uses the forecasting ML model to predict future demand for each product based on historical data, external demand signals (e.g., online search trends), and sentiment analysis of market trends. The forecasting ML model is trained to optimize business performance by minimizing stockout penalties and excess holding costs.

In the example scenario, the system 104 formulates the stochastic optimization problem where the optimal order quantity is determined by balancing the expected costs of stockouts, storage, procurement, and supplier lead times. If a supplier offers lower costs but has longer lead times, the system 104 accounts for potential shortages. Similarly, if another supplier offers faster delivery but higher prices, the system 104 optimizes the trade-off based on risk aversion parameters.

Consequently, the system 104 outputs the optimal decision variable i.e., the specific quantity of each product to order from different suppliers.

Thereafter, the company places orders based on the optimal decision variable, and after a specific period, the system 104 evaluates the actual cost outcome by measuring deviation from expected costs (e.g., storage costs were higher than projected due to unexpected demand drop), stockout occurrences (e.g., demand exceeded predictions, leading to lost sales), and supplier delays or variability impacting fulfillment efficiency.

In the example scenario, the system 104, updates the forecasting ML model using a rolling window technique if the actual demand significantly differs from predicted values, advantageously ensuring that future predictions incorporate the latest market trends and observed demand fluctuations.

In the example scenario, the system 104 evaluates the effectiveness of the previous decisions by comparing the actual cost outcome with the optimal expected performance. Consequently, based on the deviations the optimization parameters are refined (e.g., adjusting supplier selection criteria based on performance). Further, in another example scenario, assuming a corporation engages with a diverse group of suppliers, each offering varying prices, quality levels, and lead times, and operating across different countries. Such complexity is further compounded by fluctuating currency exchange rates, taxes, and transportation costs. The system 104 evaluates the effectiveness of previous supplier selection decisions based on comparing actual cost outcomes with optimal expected performance. Consequently, based on observed deviations, the system 104 refines optimization parameters, such as adjusting supplier selection criteria to improve cost efficiency. Additionally, many factors influencing supplier selection and order quantity decisions are uncertain, and the availability of reliable forecasts may vary. Therefore, in an advantageous aspect, the system 104 dynamically adapts to the uncertainties to determine the optimal order quantities for each supplier, aiming to maximize revenue or minimize operational costs while ensuring compliance with predefined constraints.

In the example scenario, the forecasting ML model is updated to better reflect demand uncertainty. Furthermore, the system 104 generates explainable task-based optimization i.e., the insights on key decision drivers, such as the influence of trend fluctuations on demand forecasts.

Therefore, in an advantageous aspect, the system 104 continuously improves inventory decision-making by aligning predictive accuracy with cost-aware optimization objectives. The company achieves lower holding costs, reduced stockout risks, and higher supply chain efficiency while maintaining an explainable decision framework that enables transparency and trust in the optimization process.

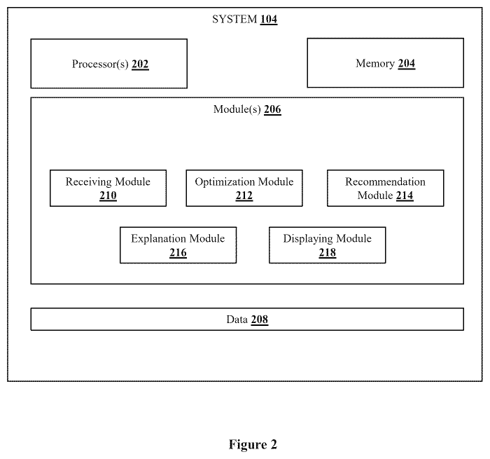

FIG. 2 illustrates a schematic block diagram of components of the system 104 for generating the explainable task-based optimization 110, according to an embodiment of the present invention.

The system 104 may include, but is not limited to, at least one processor 202 (alternatively referred to as processor), memory 204, modules 206, and data 208. The modules 206 and the memory 204 may be communicably coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

In an embodiment, the modules 206 may include a receiving module 210, an optimization module 212, a recommendation module 214, an explanation module 216, and a displaying module 218. The receiving module 210, the optimization module 212, the recommendation module 214, the explanation module 216, and the displaying module 218 may be in communication with each other. The data 208 serves, amongst other things, as a repository for storing data processed, received, and generated by one or more of the modules 206.

For the sake of brevity, the architecture, and standard operations of the memory 204 and the processor 202 are not discussed in detail. In one embodiment, the memory 204 may be configured to store the information, the input data 102 as required by the processor 202 to perform the methods described herein. A detailed description of the module 206 is provided in the further paragraphs.

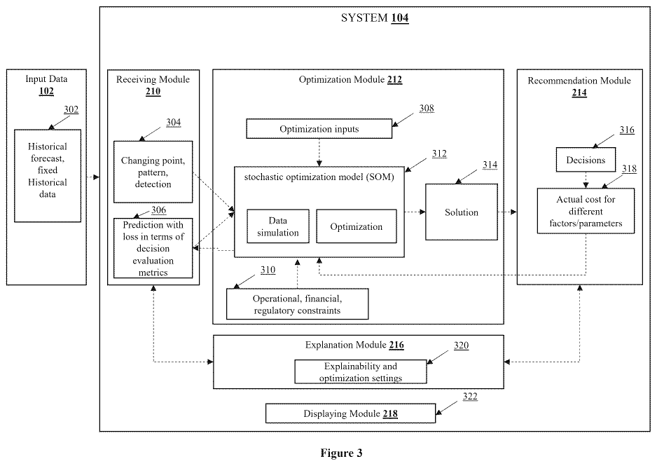

FIG. 3 illustrates an exemplary process flow of the modules 206, according to an embodiment of the present invention.

At step 302, the system 104 collects historical data and forecasting inputs, which serve as the foundational dataset for the decision-making problems. In a non-limiting example, the input data 102 includes historical records of demand patterns, past decisions, cost structures, and system constraints. The input data 102 is preprocessed and structured for further processing.

At step 304, the receiving module 210 may be configured to receive the preprocessed input data 102, including the historical demand forecasts, detected change points and patterns in demand or operational trends which may indicate possible shifts in supply chain behavior, energy consumption, or financial trends.

At step 306, the receiving module 210 may be configured to process a prediction with loss evaluation in terms of decision evaluation metrics. Consequently, this allows for quantifying forecasting accuracy and assessing prediction-based decision performance before optimization. The receiving module 210 may include the forecasting ML model for generating future estimates and evaluating prediction accuracy. Thus, the forecasting ML model is configured to generate the time-series forecasting or demand prediction using historical data, pattern detection and change-point analysis to identify shifts in trends and evaluate prediction loss using decision evaluation metrics to assess forecasting accuracy.

At step 308, the optimization module 212 may be configured to receive the optimization inputs. The stochastic optimization model (SOM) within the optimization module 212 receives optimization-related inputs, such as cost model parameters (e.g., purchase costs, salvage values, stockout penalties), risk aversion parameters (e.g., penalties for uncertain demand, variability in energy load, or financial volatility), the auxiliary datasets that inform decision-making (e.g., supplier quality data, shipping lead times, or inventory storage conditions).

At step 310, the optimization module 212 may be configured to receive the constraints input. In an example, the SOM receives various constraints that guide the optimization process. In an non-limiting example, the constraints may include the operational constraints (e.g., maximum storage capacity, machine availability), financial constraints (e.g., budget limitations, pricing rules), and regulatory constraints (e.g., compliance with environmental laws, labor regulations, or industry standards).

At step 312, the SOM may be configured to integrate the predicted target decision variable (from the forecasting ML model), the optimization inputs (cost models, risk parameters), and the operational, financial, and regulatory constraints.

Accordingly, the SOM performs data simulation and applies an optimization framework to determine the optimal decision variable. The optimal decision variable is computed or determined based on solving the stochastic optimization problem, ensuring that constraints and uncertainties are properly addressed.

At step 314, the SOM may be configured to generate the solution. In an example, the SOM produces an optimal solution, which represents a recommended decision for execution. The decision is generated to minimize cost, optimize resource allocation, and mitigate risks based on the stochastic nature of the decision-making problem (the stochastic optimization problem).

At step 316, the recommendation module 214 may be configured to receive the optimized decision and generate final decision recommendations for execution.

At step 318, the recommendation module 214 may be configured to evaluate the actual cost outcome, based on the execution of the decision and alignment with the expected optimal performance. Thus, the system 104 compares the actual cost against the forecasted expected cost to determine if any deviations may exist. In a scenario, if the actual cost outcome deviates from the expected optimal performance, the actual cost outcome may be fed back into the SOM for further refinement.

Consequently, the optimization parameters (e.g., cost penalties, risk factors, decision thresholds) are updated based on the observed deviations. Advantageously, the iterative reinforcement mechanism allows the system 104 to continuously improve decision accuracy over time.

At step 320 the explanation module 216 may be configured to generate explainability insights regarding the decision-making process. Thus, the key factors that influence optimization, such as supply chain variability, demand fluctuations, or cost-risk trade-offs are explained. Further, optimization settings are generated detailing the impact of the constraints, the risk aversions, and the cost parameters on the final decision. In a non-limiting example, techniques such as SHAP (Shapley Additive Explanations) and LIME (Local Interpretable Model-Agnostic Explanations) may be used to highlight important key factors behind the decision outcome.

At step 322 the displaying module 218 may be configured to display the explainable task-based optimization solutions 110 (the insights 110) generated on the output console 106.

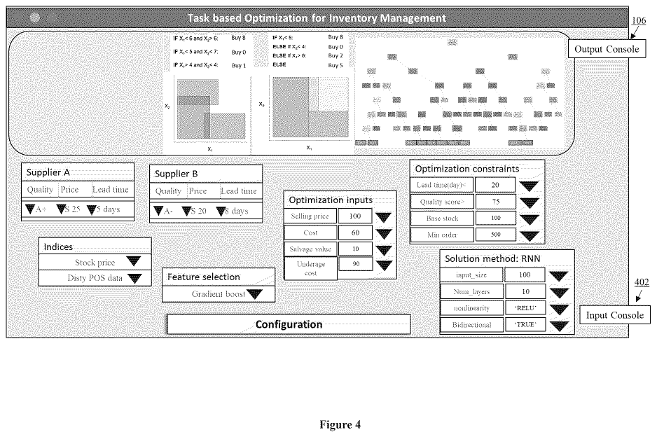

FIG. 4 illustrates an use-case depicting the generation of the explainable task-based optimization 110 on the output console 106 or graphical user interface (GUI), according to an embodiment of the present invention.

As depicted, the explainable task-based optimization 110 is presented via an interactive interface comprising an input console 402 and the output console 106 of the system 104. The input console 402 enables the user to provide the input data 102, which may include supplier information, optimization inputs, optimization constraints, feature selection parameters, and the selected solution techniques. Additionally, the system 104 may allow the user to configure specific task-based settings or define business objectives for optimization. Thus, once the necessary inputs are provided, the user may trigger a request via the input console 402, prompting the system 104 to process the optimization task of the system 104. In response, the system 104 generates the explainable task-based optimization 110, which is displayed on the output console 106. The output console 106 presents the computed optimization results along with explainability insights, allowing the user to review the reasoning behind the generated solutions, key influencing factors, and the overall performance of the optimization.

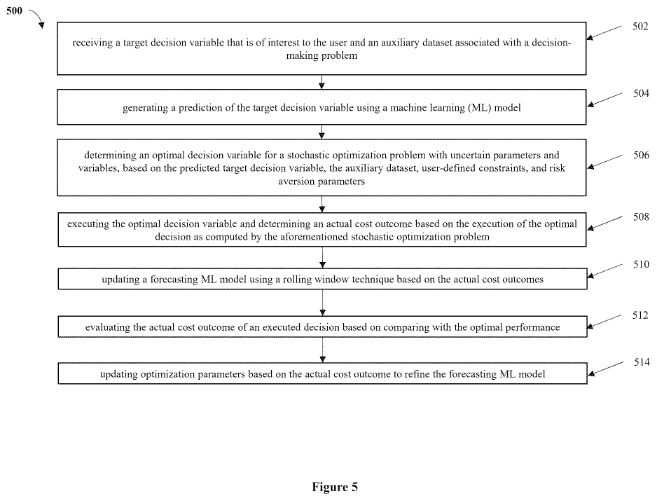

FIG. 5 illustrates a flowchart depicting a method 500 for generating the explainable task-based optimization 110 using the system 104, according to an embodiment of the present invention. The method 500 may be performed by the system 104, in particular, the processor 202 of the system 104. For the sake of brevity, the steps explained in FIG. 1-FIG. 4 are not repeated in the following FIG. 5.

At step 502, the method 500 may include receiving the target decision variable that is of interest to the user and the auxiliary dataset associated with the decision-making problem.

At step 504, the method 500 may include generating the prediction of the target decision variable using the forecasting machine learning (ML) model.

At step 506, the method 500 may include determining an optimal decision variable for the decision-making problem with uncertain parameters and variables, based on the predicted target decision variable, the auxiliary dataset, user-defined constraints, and risk aversion parameters.

At step 508, the method 500 may include executing the optimal decision variable and determining an actual cost outcome based on the execution of the optimal decision as computed by the aforementioned stochastic optimization problem.

At step 510, the method 500 may include updating the forecasting ML model using a rolling window technique based on the actual cost outcomes.

At step 512, the method 500 may include evaluating the actual cost outcome of an executed decision based on comparing with the optimal performance.

At step 514, the method 500 may include updating optimization parameters based on the actual cost outcome to refine the forecasting ML model.

The present disclosure provides the following advantages:
The present disclosure integrates the forecasting ML model with the stochastic optimization model (SOM), thus refining predictions and optimising decision variables based on real-world constraints and uncertainties.
The present disclosure continuously updates optimization parameters using real-time feedback from actual cost outcomes, ensuring adaptive and resilient decision-making.
The present disclosure customizes optimization solutions for different business scenarios by considering domain-specific constraints, risk factors, and auxiliary datasets.
The present disclosure includes explanation techniques such as SHAP, LIME, and other interpretability techniques that provides transparency in decision-making, helping users understand key influencing factors.
The present disclosure uses the rolling window technique to update forecasting models dynamically, reducing performance degradation over time.
The present disclosure incorporates risk aversion parameters ensuring that decisions balance cost efficiency with risk mitigation.
The present disclosure uses auxiliary datasets, including real-time trends and sentiment analysis, to improve optimization accuracy.
The present disclosure applies to multiple domains, such as supply chain management, inventory optimization, energy distribution, and financial decision-making.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for explainable task-based optimization, the method comprising:
receiving a target decision variable that is of interest to the user and an auxiliary dataset associated with a decision-making problem;
generating a prediction of the target decision variable using a forecasting machine learning (ML) model;
determining an optimal decision variable for the decision-making problem with uncertain parameters and variables, based on the predicted target decision variable, the auxiliary dataset, user-defined constraints, and risk aversion parameters;
executing the optimal decision variable and determining an actual cost outcome based on the execution of the optimal decision as computed for the decision-making problem;
updating the forecasting ML model using a rolling window technique based on the actual cost outcomes;
evaluating the actual cost outcome of an executed decision based on comparing with the optimal performance; and
updating optimization parameters based on the actual cost outcome to refine the forecasting ML model.

2. The method of claim 1, wherein the auxiliary dataset includes at least one of ordering history, storage constraints, shortfall costs, salvage value, shelf life, or external demand indicators.

3. The method of claim 1, wherein the actual cost outcome indicates the realized impact of an executed decision on the end to end system measured with respect to a specific objective function, customized for the task at hand, including deviations from expected costs could have been achieved otherwise, constraint violations, risk exposure, decision robustness, and overall system performance.

4. The method of claim 1, wherein the optimization parameters include penalties for constraint violations, risk-adjusted cost deviations.

5. The method of claim 1, wherein the auxiliary dataset is received from an integrated external auxiliary data sources, wherein the external auxiliary data sources comprise real-time web search trend analysis, sentiment analysis using large language models (LLMs) and topic modelling based on historical demand patterns.

6. The method of claim 1, wherein the user-defined constraints and risk version parameters comprises inventory thresholds, supply chain constraints, or energy consumption limits to ensure business-specific compliance.

7. The method of claim 1, wherein updating of the optimization parameters comprises:
adjusting the optimization parameters based on observed deviations from expected results based on the actual cost outcome.

8. The method of claim 1, comprising:
generating an explanation for the optimal decision variable based on mapping an impact of forecast adjustments, optimization constraints, and the loss function with external market factors, thereby enhancing interpretability and facilitating user adoption, wherein the explanation is generated using SHAP (Shapley Additive Explanations) values or LIME (Local Interpretable Model-Agnostic Explanations), tree based, deep learning to highlight key drivers influencing the optimization and computing the corresponding decision variables.

9. A system for explainable task-based optimization, the system comprising:
a memory;
at least one processor in communication with the memory, the at least one processor configured to:
receive a target decision variable that is of interest to the user and an auxiliary dataset associated with a decision-making problem;
generate a prediction of the target decision variable using a forecasting machine learning (ML) model;
determine an optimal decision variable for the decision-making problem with uncertain parameters and variables, based on the predicted target decision variable, the auxiliary dataset, user-defined constraints, and risk aversion parameters;
execute the optimal decision variable and determining an actual cost outcome based on the execution of the optimal decision as computed for the decision-making problem;
update the forecasting ML model using a rolling window technique based on the actual cost outcomes;
evaluate the actual cost outcome of an executed decision based on comparing with the optimal performance; and
update optimization parameters based on the actual cost outcome to refine the forecasting ML model.

10. The system of claim 9, wherein the auxiliary dataset includes at least one of ordering history, storage constraints, shortfall costs, salvage value, shelf life, or external demand indicators.

11. The system of claim 9, wherein the actual cost outcome indicates the realized impact of an executed decision on the end to end system measured with respect to a specific objective function, customized for the task at hand, including deviations from expected costs could have been achieved otherwise, constraint violations, risk exposure, decision robustness, and overall system performance.

12. The system of claim 9, wherein the optimization parameters include penalties for constraint violations, risk-adjusted cost deviations.

13. The system of claim 9, wherein the auxiliary dataset is received from an integrated external auxiliary data sources, wherein the external auxiliary data sources comprise real-time web search trend analysis, sentiment analysis using large language models (LLMs) and topic modelling based on historical demand patterns.

14. The system of claim 9, wherein the user-defined constraints and risk version parameters comprises inventory thresholds, supply chain constraints, or energy consumption limits to ensure business-specific compliance.

15. The system of claim 9, wherein updating of the optimization parameters comprises:
adjusting the optimization parameters based on observed deviations from expected results based on the actual cost outcome.

16. The system of claim 9, wherein the at least one processor is configured to:
generate an explanation for the optimal decision variable based on mapping an impact of forecast adjustments, optimization constraints, and the loss function with external market factors, thereby enhancing interpretability and facilitating user adoption, wherein the explanation is generated using SHAP (Shapley Additive Explanations) values or LIME (Local Interpretable Model-Agnostic Explanations), tree based, deep learning to highlight key drivers influencing the optimization and computing the corresponding decision variables.
